(19) United States
(12) Patent Application Publication
(10) Pub. No.: US 2025/0316784 A1
(43) Pub. Date: Oct. 9, 2025

(54) Vehicle and Method of Controlling the Same

(71) Applicants: Hyundai Motor Company, Seoul (KR); Kia Corporation, Seoul (KR)

(72) Inventor: Kyung Sang Yu, Hwaseong-Si (KR)

(21) Appl. No.: 18/908,255

(22) Filed: Oct. 7, 2024

(30) Foreign Application Priority Data
Apr. 8, 2024 (KR) 10-2024-0047547

(51) Int. Cl. H01M 10/625; B60K 11/00; B60L 58/24; B60R 16/08; H01M 10/613; H01M 10/6561

(52) U.S. Cl. CPC H01M 10/625; B60R 16/08; H01M 10/613; H01M 10/6561; B60K 11/00; B60L 58/24; H01M 2220/20

(57) ABSTRACT

A vehicle may comprise an inlet part having a first hole configured to communicate with an internal space of the vehicle, a second side comprising an outlet part having a second hole, a connection duct provided to face the outlet part and having a connection flow path configured to connect the outlet part and the internal space, and an opening/closing part provided at one side of the connection duct and configured to control opening and closing between a region of the connection flow path, which faces the outlet part, and another region, in which the first hole and the second hole communicate with the cooling flow path.

### CROSS-REFERENCE TO RELATED APPLICATION

This application claims priority to and the benefit of Korean Patent Application No. 10-2024-0047547 filed in the Korean Intellectual Property Office on Apr. 8, 2024, the entire contents of which are incorporated herein by reference.

### TECHNICAL FIELD

The present disclosure relates to a vehicle and a method of controlling the same,

and more particularly, to a vehicle, in which a flow path through which a cooling fluid for cooling a battery flows is provided, and a method of controlling the same.

### BACKGROUND ART

A vehicle equipped with a battery may also be provided with a cooling system for cooling the battery. Methods of cooling batteries may be classified into an air-cooled type and/or a water-cooled type depending on the types of fluids used to cool the batteries. For air-cooling batteries, a method of supplying air from an internal space of the vehicle to the cooling system and then discharging the air from the cooling system back into the internal space of the vehicle is often used.

An external impact or the like applied to the battery may cause an accident, such as a fire in the battery or thermal runaway. In this case, a gas may be produced from a material in the battery.

In the case of an air-cooled battery in the related art, in which the battery is cooled by air supplied from the internal space of the vehicle, the gas produced from the battery may be introduced into the internal space of the vehicle, which may cause a problem in that the safety of occupants in the vehicle cannot be ensured.

### SUMMARY

The following summary presents a simplified summary of certain features. The summary is not an extensive overview and is not intended to identify key or critical elements.

Systems, apparatuses, and methods are described for a vehicle and method of controlling the same. A vehicle may comprises a battery; a cooling flow path configured to cool the battery via a fluid flowing through the cooling flow path; an inlet forming a first hole in a first side of the vehicle, wherein the first hole is configured to communicate with an internal space of the vehicle; an outlet forming a second hole in a second side of the vehicle; a connection duct forming a connection flow path configured to connect the outlet and the internal space of the vehicle; and an opening/closing part configured to control opening or closing between a first region, of the connection flow path, facing the outlet, and a second region, of the connection flow path, away from the outlet, wherein the first hole and the second hole are in communication with the cooling flow path.

A method of controlling the vehicle may comprise closing, based on a temperature of the battery exceeding a threshold temperature and via the opening/closing part, a part of the connection flow path; and discharging, based on a pressure in a region of the connection flow path adjacent to a discharge hole satisfying a threshold pressure, the fluid in the connection flow path to an outside of the vehicle via the discharge hole. The closing may configure the opening/closing part to prevent the fluid, introduced into the connection flow path via the second hole, from reaching the internal space of the vehicle.

These and other features and advantages are described in greater detail below.

### BRIEF DESCRIPTION OF THE DRAWINGS

The above and other objects, features and advantages of the present disclosure will be more apparent from the following detailed description taken in conjunction with the accompanying drawings:

FIG. 1 is a top plan view illustrating a vehicle according to the present disclosure.

FIG. 2 is an enlarged view illustrating a connection duct, an opening/closing part, and peripheral components in a state in which a seat of the vehicle according to the present disclosure is removed.

FIG. 3 is an enlarged view illustrating the connection duct, the opening/closing part, and the peripheral components in a state in which the seat of the vehicle according to the present disclosure is disposed.

FIG. 4 is a view illustrating a flow direction of a fluid in a state in which a blocking member of an opening/closing part of the vehicle according to the present disclosure opens a connection flow path.

FIG. 5 is a vertical cross-sectional view illustrating a relative positional relationship between the connection flow path and the blocking member in FIG. 4.

FIG. 6 is a view illustrating a flow direction of the fluid in a state in which the blocking member of the opening/closing part of the vehicle according to the present disclosure closes the connection flow path.

FIG. 7 is a vertical cross-sectional view illustrating a relative positional relationship between the connection flow path and the blocking member in FIG. 6.

### DETAILED DESCRIPTION

Hereinafter, a vehicle and a method of controlling the same according to the present disclosure will be described with reference to the drawings. In adding the reference numerals to the components of each drawing, it should be noted that the identical or equivalent component is specified by the identical numeral throughout the drawings. Further, in describing the example of the present disclosure, a detailed description of the related known configuration or function will be omitted if it is determined that it interferes with the understanding of the example of the present disclosure.

Also, or alternatively, terms, such as first, second, or the like may be used herein in describing components of the present disclosure. The terms are provided only to distinguish the elements from other elements, and the essences, sequences, orders, and numbers of the elements are not limited by the terms. Also, or alternatively, unless defined otherwise, all terms used herein, including technical or scientific terms, have the same meanings as those generally understood by those skilled in the art to which the present disclosure pertains. The terms defined in the generally used dictionaries should be construed as having the meanings that coincide with the meanings of the contexts of the related technologies, and should not be construed as ideal or excessively formal meanings unless clearly defined in the specification of the present disclosure.

### Vehicle

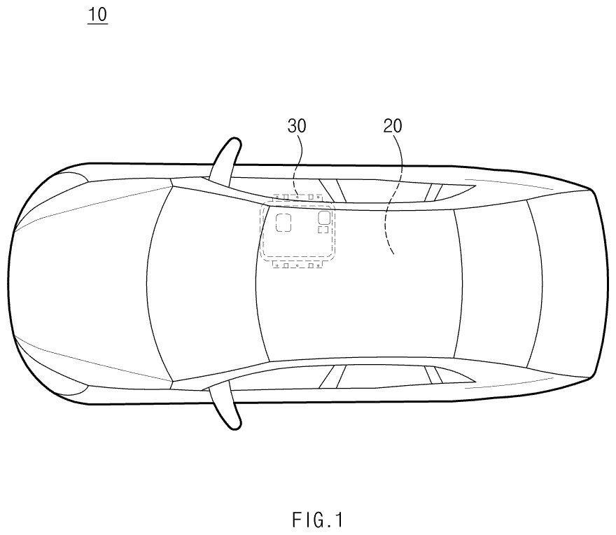

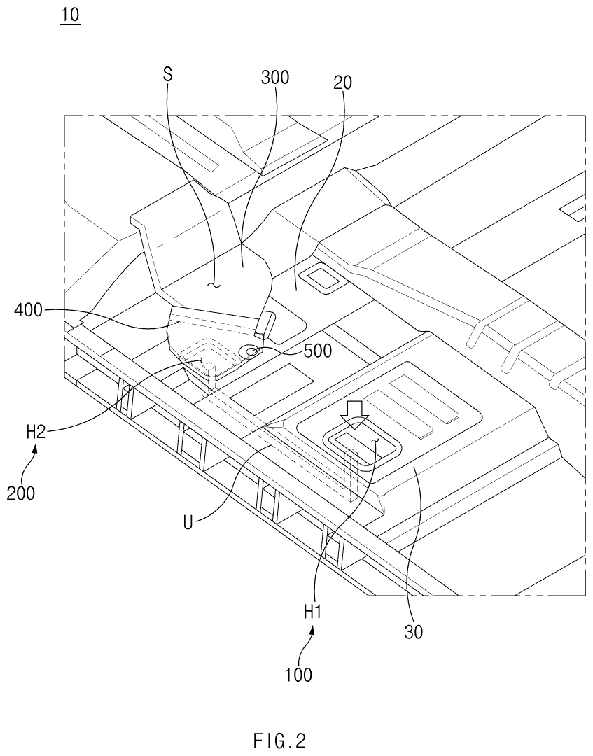

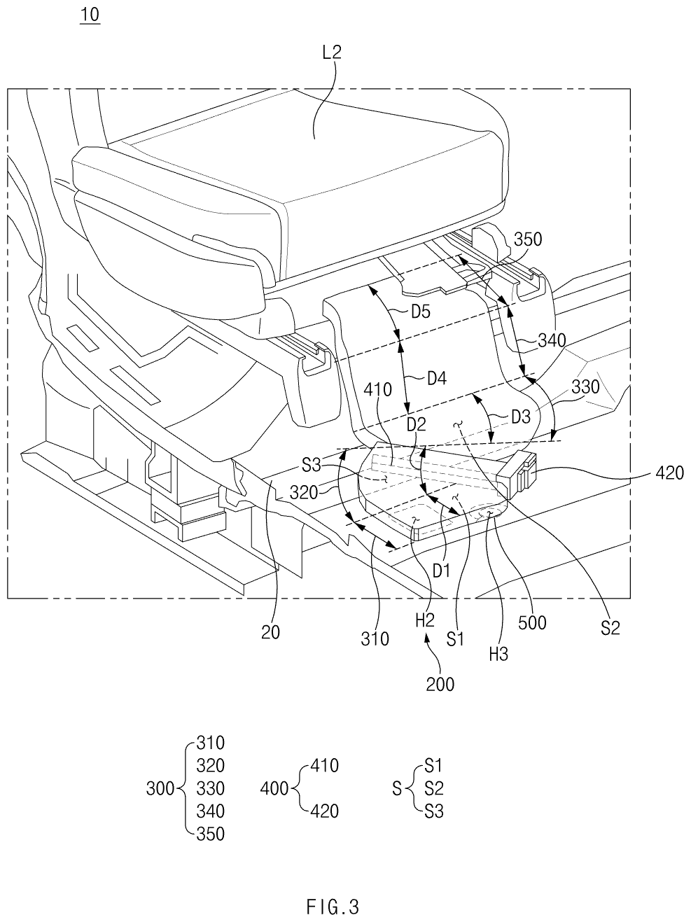

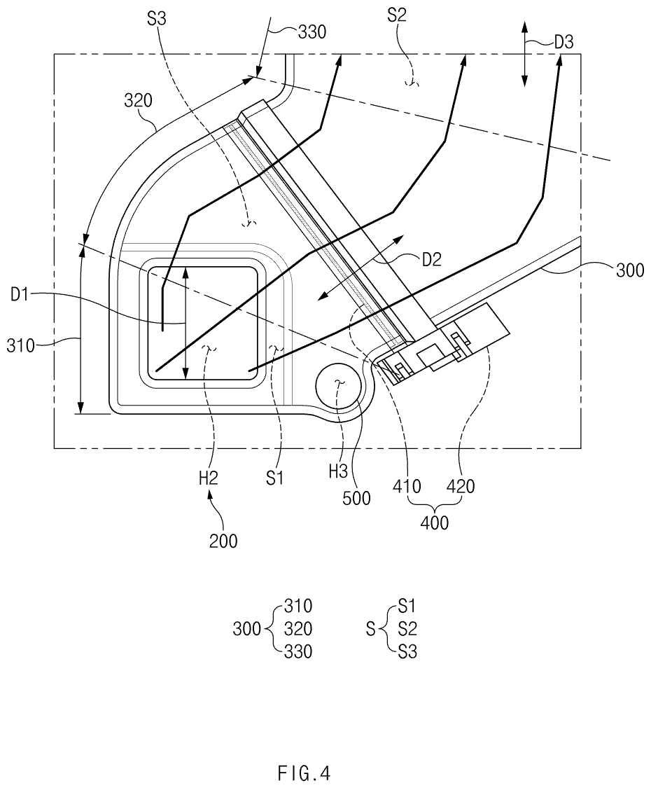

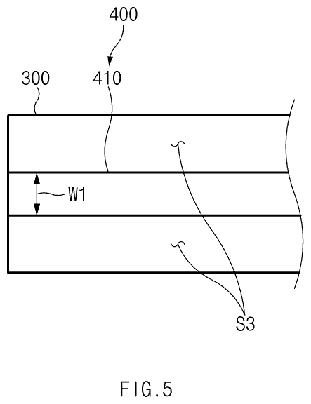

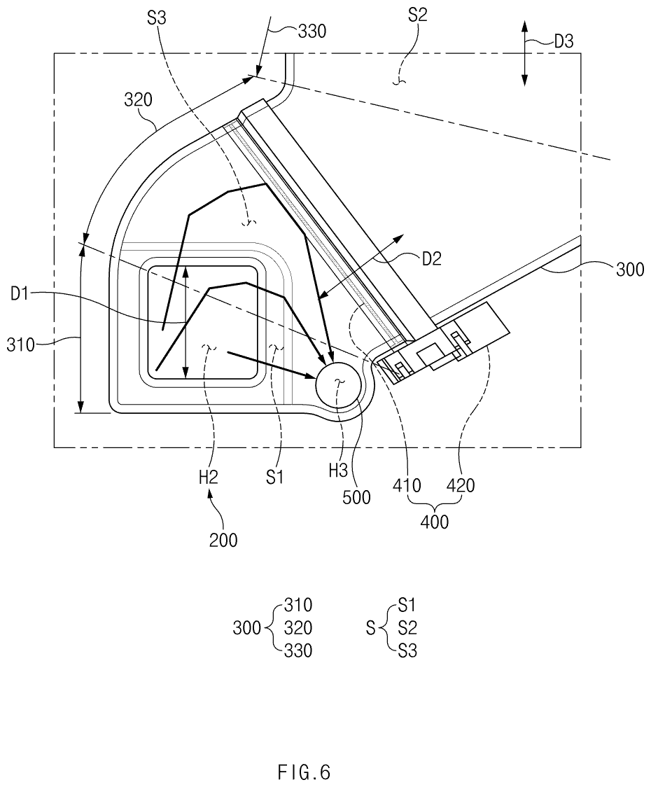

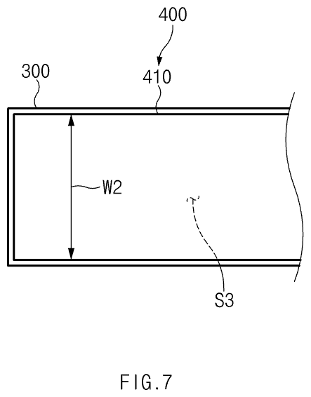

FIG. 1 is a top plan view illustrating a vehicle according to the present disclosure, and FIG. 2 is an enlarged view illustrating a connection duct, an opening/closing part, and peripheral components in a state in which a seat of the vehicle according to the present disclosure is removed. FIG. 3 is an enlarged view illustrating the connection duct, the opening/closing part, and the peripheral components in a state in which the seat of the vehicle according to the present disclosure is disposed, and FIG. 4 is a view illustrating a flow direction of a fluid in a state in which a blocking member of an opening/closing part of the vehicle according to the present disclosure opens a connection flow path. FIG. 5 is a vertical cross-sectional view illustrating a relative positional relationship between the connection flow path and the blocking member in FIG. 4, and FIG. 6 is a view illustrating a flow direction of the fluid in a state in which the blocking member of the opening/closing part of the vehicle according to the present disclosure closes the connection flow path. Also, or alternatively, FIG. 7 is a vertical cross-sectional view illustrating a relative positional relationship between the connection flow path and the blocking member in FIG. 6.

The vehicle according to the present disclosure may include a battery. For example, the vehicle according to the present disclosure may be an electric vehicle that operates by using electrical energy stored in the battery as a power source. Also, or alternatively to the electric vehicle, the present disclosure may also be applied to an internal combustion engine vehicle equipped with a battery.

A battery 30 mounted in a vehicle 10 according to the present disclosure may include a battery module, which includes a plurality of battery cells, and a battery pack. In this case, the vehicle 10 according to the present disclosure may include the battery 30, and a cooling flow path U for cooling the battery 30.

Air, which is a cooling fluid used to cool the battery 30, may flow in the cooling flow path U. In this case, the air flowing in the cooling flow path U may be introduced from an internal space of the vehicle 10, i.e., a space in which occupants including a driver are seated. The internal space of the vehicle 10 may be understood as including a trunk space of the vehicle without being limited to the space in which the occupant is seated. That is, according to the present disclosure, at one side of the cooling flow path U, the air may be introduced into the cooling flow path U from the internal space of the vehicle. The air may cool the battery 30 (e.g., as it flows through the cooling flow path U) and then be discharged to the outside of the cooling flow path U. In this case, at an ordinary time (e.g., in a case that no thermal runaway is occurring), the air discharged from the cooling flow path U may be discharged back into the internal space of the vehicle 10. As described herein, in case that there is a concern (e.g., possibility/probability/prediction) that a material other than air may be discharged from the battery 30 (e.g., due to of thermal runaway of the battery 30), the air discharged from the cooling flow path U may be discharged to the outside of the vehicle 10 without being discharged into the internal space of the vehicle 10.

With reference to FIGS. 2 and 3, the vehicle 10 according to the present disclosure may include an inlet part 100 (e.g., an inlet) provided at one side of the vehicle and having a first hole H1 configured to communicate with the internal space of the vehicle, and an outlet part 200 (e.g., an outlet) provided at the other side of the vehicle and having a second hole H2. The first hole H1 may be configured to define a route through which the air in the internal space of the vehicle 10 is introduced into the cooling flow path U. The second hole H2 may define a part of a route through which the air introduced into the cooling flow path U is discharged back into the internal space of the vehicle 10 after cooling the battery. Therefore, according to the present disclosure, the first hole H1 and the second hole H2 may communicate with the cooling flow path U.

According to the present disclosure, the air, which is discharged through the second hole H2 after flowing through the cooling flow path U, may flow through a flow path of a predetermined duct configuration and then be discharged into the internal space of the vehicle without immediately discharged into the internal space of the vehicle.

In order to define the flow path for the air, the vehicle 10 according to the present disclosure may further include a connection duct 300 provided to face the outlet part 200 and having a connection flow path S configured to connect the outlet part 200 and the internal space of the vehicle 10. That is, according to the present disclosure, at an ordinary time if thermal runaway or the like does not occur in the battery 30, the air, which is discharged through the second hole H2 after flowing through the cooling flow path U, may flow through the connection flow path S of the connection duct 300 and then be introduced into the internal space of the vehicle 10. As described herein, the first hole H1 is a region into which the air is introduced from the internal space of the vehicle. Therefore, as the first hole H1 is spaced apart from the connection duct 300, the first hole H1 may be physically spaced apart from the connection flow path S, and the first hole H1 may be provided to communicate directly with the internal space of the vehicle.

With continued reference to FIGS. 2 and 3, a discharge hole H3 may be further provided at the other side of the vehicle 10 according to the present disclosure and allow an external space of the vehicle and the connection flow path S to communicate with each other. The discharge hole H3 may be configured to define a part of a route through which the fluid, which is discharged through the second hole H2 after flowing through the cooling flow path U, is discharged to the external space of the vehicle 10 in case that a gas in the battery 30, which is produced by thermal runaway or the like of the battery 30, is highly likely to be introduced into the internal space of the vehicle 10.

The first hole H1, the second hole H2, and the discharge hole H3 may be formed in a floor surface of the vehicle 10. More specifically, the first hole H1, the second hole H2, and the discharge hole H3 may be formed in a floor member that defines a lower region of a vehicle body of the vehicle 10.

With continued reference to FIGS. 2 and 3, the vehicle 10 according to the present disclosure may include an opening/closing part 400 provided at one side of the connection duct 300 and configured to control the opening and closing between a region of the connection flow path S, which faces the outlet part 200, and another region. The opening/closing part 400 may be configured to open the connection flow path S at an ordinary time so that the fluid, which is introduced into the connection flow path S through the second hole H2 formed in the outlet part 200, may flow through the connection flow path S and then be introduced into the internal space of the vehicle 10. In case that there is a concern that a gas is produced from the battery because of an abnormal operation of the battery, such as thermal runaway of the battery, the opening/closing part 400 may close a part of the connection flow path S to prevent the fluid, which is introduced into the connection flow path S through the second hole H2, from being introduced into the internal space of the vehicle 10. As illustrated in FIGS. 2 and 3, at least some components (a blocking member to be described below) of the opening/closing part 400, the second hole H2, and the discharge hole H3 may be provided in a space defined by the connection flow path S.

The connection flow path S may be divided into a plurality of spaces (e.g., may be described with reference to a plurality of defined spaces, which may be contiguous or separate from each other). More specifically, the connection flow path S may include a first flow path space S1 provided adjacent to the second hole H2 and the discharge hole H3, a second flow path space S2 configured to communicate with the internal space of the vehicle 10, and an intermediate space S3 configured to connect the first flow path space S1 and the second flow path space S2. Therefore, at an ordinary time (e.g., if thermal runaway of the battery is not occurring), the fluid, which may be introduced from the cooling flow path U through the second hole H2, may sequentially pass through the first flow path space S1, the intermediate space S3, and the second flow path space S2 and then be discharged into the internal space of the vehicle.

In this case, with reference to FIGS. 4 and 7, the opening/closing part 400 may include a blocking member 410 configured to be movable between a first state in which the blocking member 410 opens the intermediate space S3 of the connection flow path S and a second state in which the blocking member 410 closes the intermediate space S3, and a power supply member 420 (e.g., a power supply/motor) configured to operate the blocking member 410. That is, the blocking member 410 may be provided in the intermediate space S3. The blocking member 410 may be a blocking structure configured to block/stop/obstruct the connection flow path S in the intermediate space S3. The power supply member 420 may be an electric motor such as a servo motor.

The power supply member 420 may include a rotary shaft configured to be rotatable, and the blocking member 410 may be coupled to the rotary shaft. If the rotary shaft performs a rotational motion, the blocking member 410 may also perform a rotational motion. Therefore, the blocking member 410 may reversibly switch from the first state to the second state and/or from the second state to the first state in accordance with a rotation angle of the blocking member 410 (e.g., controlled by the power supply member 420).

For example, the blocking member 410 may have an approximately rod shape extending in a longitudinal direction of the rotary shaft. An extension direction of a region of the connection flow path S, in which the rotary shaft and the blocking member 410 may be provided, may intersect the longitudinal direction of the rotary shaft and the blocking member 410. The extension direction of the region of the connection flow path S, in which the rotary shaft and the blocking member 410 may be provided, may perpendicularly intersect the longitudinal direction of the rotary shaft and the blocking member 410. The extension direction of the connection flow path S and/or the connection duct 300 is defined herein as a flow direction in which a fluid would through the connection flow path S in a case that thermal runaway of the battery is not occurring. For example, the longitudinal direction of the blocking member 410 and the rotary shaft may be parallel to the horizontal direction.

With reference to FIGS. 5 and 7, the blocking member 410 may have a first width W1 in a direction perpendicular to the longitudinal direction of the rotary shaft and have a second width W2 in a direction perpendicular to the longitudinal direction of the rotary shaft and the direction of the first width W1. For example, in case that a cross-section, which is made by cutting the blocking member 410 in the direction perpendicular to the longitudinal direction of the blocking member 410, has a rectangular shape, a length of one side of the rectangular shape may correspond to the first width W1, and a length of another side of the rectangular shape may correspond to the second width W2.

According to the present disclosure, a surface of the blocking member 410, which defines the first width W1, may be provided to face, in the flow direction of the fluid, the fluid flowing through the connection flow path S in the first state. A surface of the blocking member 410, which defines the second width W2, may be provided to face, in the flow direction of the fluid, the fluid flowing through the connection flow path S in the second state. As described herein, because the intermediate space S3 of the connection flow path S is opened in the first state, the fluid passes through the intermediate space S3 and reach the second flow path space S2. Because the intermediate space S3 of the connection flow path S is closed in the second state, the fluid cannot pass through the intermediate space S3 nor reach the second flow path space S2.

The opening/closing part 400 may also, or alternatively, not be operated by the power supply member. For example, the opening/closing part 400 may include the blocking member 410 provided in the intermediate space S3 configured to connect the first flow path space S1, which is provided adjacent to (which is connected to/in communication with) the second hole H2 and the discharge hole H3, and the second flow path space S2 that communicates with the internal space of the vehicle. In this case, the blocking member 410 may be a member that changes in volume (e.g., depending on a temperature, for example). For example, in case that a temperature exceeds a predetermined value, the blocking member 410 may increase in volume and close the intermediate space S3. For example, the blocking member 410 may include a foaming agent that increases in volume by a chemical reaction if a temperature exceeds the predetermined value. The principle of increasing the volume of the blocking member 410 is not limited to the configuration/example described herein, and may be achieved in various ways within the range readily employed by one of ordinary skill in the art to which the present disclosure pertains.

The first width W1 may be smaller than a width in a first direction (e.g., an upward/downward direction) of a region (i.e., the intermediate space S3) of the connection flow path S in which the blocking member 410 is provided. The second width W2 may correspond to or be equal to the width in the first direction (e.g., the upward/downward direction) of the region of the connection flow path S in which the blocking member 410 is provided. In this case, the power supply member 420 may operate in the first state so that the blocking member 410 is oriented to have a first dimension characterized by the first width W1 parallel to the first direction (e.g., the upward/downward direction). The power supply member 420 may operate in the second state so that the blocking member 410 is oriented to have a second dimension characterized by the second width W2 parallel to the first direction (e.g., the upward/downward direction).

As illustrated in FIGS. 2, 3, 4, and 6, the vehicle 10 according to the present disclosure may further include a vent member 500 provided in the discharge hole H3 and configured to close the discharge hole H3. If the applied pressure exceeds (e.g., meets and/or exceeds and/or satisfies) a predetermined pressure (a threshold pressure), the vent member 500 may open the discharge hole H3.

In case that the fluid, introduced into the connection flow path S through the first hole H1, is discharged into the internal space of the vehicle in the first state, the vent member 500 may close the discharge hole H3 and serve to prevent the fluid in the connection duct 300 from being discharged to the external space of the vehicle. In case that the fluid, introduced into the connection flow path S through the first hole H1, needs to be discharged to the external space of the vehicle, (e.g., in the second state), the vent member 500 may open the discharge hole H3 and serve to discharge the fluid in the connection duct 300 to the external space of the vehicle. For example, if a pressure exceeds a predetermined pressure, a partial region of the vent member 500 may be fractured to open the discharge hole H3. As another example, the vent member 500 may be a component, such as a relief valve or a safety valve, that may reversibly switch between the opened state and the closed state of the discharge hole H3 in accordance with a change in pressure.

With continued reference to FIGS. 1 to 3, the first hole H1 and the discharge hole H3 of the vehicle 10 according to the present disclosure may be provided between a front seat (not illustrated) of the vehicle 10 and a rear seat L2 positioned rearward of the front seat. In this case, in the present specification, the front seat and the rear seat are relative concepts. Among the seats spaced apart from one another in the forward/rearward direction, the seat positioned at a relatively front side of the vehicle is defined as the front seat, and the seat, which is positioned at a relatively rear side of the vehicle compared to the front seat, is defined as the rear seat.

The second hole H2 may be formed in a lower region of the rear seat L2. For example, as illustrated in FIGS. 2 and 3, in a floor surface 20 of the vehicle 10, a stepped portion may be formed in the upward/downward direction between i) the region between the front seat and the rear seat L2 and ii) the lower region of the rear seat L2. The lower region of the rear seat L2 may protrude relatively further upward than the region between the front seat and the rear seat L2. The second hole H2 may be positioned above (relative to a floor of the vehicle) the first hole H1 and the discharge hole H3.

Also, or alternatively, the connection duct 300 of the vehicle 10 according to the present disclosure may have a structure securely fixed to the floor surface 20 of the vehicle 10. To this end, according to the present disclosure, a horizontal width of a cross-section, which is made by cutting the connection duct 300 in a direction perpendicular to the extension direction of the connection duct 300, may be larger than a height in the upward/downward direction. This configuration may be understood as a configuration in which the cross-section of the connection duct 300 has a shape longer in the horizontal direction.

In this case, at least a part of a lower surface of the connection duct 300 may be tightly fixed to the floor surface 20. More specifically, the entirety or most part of the lower surface of the connection duct 300 may be tightly fixed to the floor surface 20. In this case, the connection duct 300 may be more securely fixed to the floor surface 20 of the vehicle 10. For example, the connection duct 300 may be manufactured by an injection molding process so that the connection duct 300 has the above-mentioned shape.

As described herein, the opening/closing part 400 may be configured to control the opening and closing of the intermediate space S3. The opening/closing part 400 may be configured to close the intermediate space S3 in case that there is a concern that a gas is produced from the battery 30 because of thermal runaway or the like of the battery 30. The occurrence of thermal runaway of the battery 30 may be estimated by measuring a temperature of the battery 30. Therefore, according to the present disclosure, in case that a temperature of at least a partial region of the battery 30 satisfies (e.g., meets and/or exceeds) a predetermined temperature (e.g., a threshold temperature), the opening/closing part 400 may operate to close a part (i.e., the intermediate space S3) of the connection flow path S.

With reference to FIGS. 2 and 3, the connection duct 300 may be divided into a plurality of regions in the extension direction.

More specifically, the connection duct 300 may include a first duct region 310 extending in a first direction D1 and configured to define the region (i.e., the first flow path space S1) of the connection flow path S that faces the first hole H1 and the discharge hole H3, a second duct region 320 extending in a second direction D2 from an end of the first duct region 310, and a third duct region 330 extending in a third direction D3 from an end of the second duct region 320. The first to third duct regions 310, 320, and 330 may be provided in a region of the floor surface 20 of the vehicle disposed between the front seat and the rear seat L2. For example, the first to third directions D1, D2, and D3 may be formed in parallel with the horizontal direction, and the second direction D2 may be formed to have a predetermined angle with respect to the first direction D1 and the third direction D3. For example, FIGS. 2 and 3 illustrate that the first direction D1 and the third direction D3 are formed in parallel with the forward/rearward direction of the vehicle 10, and the second direction D2 extends obliquely and has a predetermined angle with respect to the forward/rearward direction and the leftward/rightward direction.

The blocking member 410 may be configured to open or close the connection flow path of the connection flow path S defined by the second duct region 320. That is, the intermediate space S3 may be the connection flow path defined by the second duct region 320, and the blocking member 410 may be inserted into the second duct region 320.

Also, or alternatively, the connection duct 300 may further include a fourth duct region 340 extending upward from an end of the third duct region 330, and a fifth duct region 350 extending from an end of the fourth duct region 340. The fourth duct region 340 may be provided to face the stepped region provided between i) the region between the front seat and the rear seat L2 and ii) the lower region of the rear seat L2. The fifth duct region 350 may be provided to face the lower region of the rear seat L2. The fifth duct region 350 may communicate directly with the internal space of the vehicle. For example, the fifth duct region 350 may extend in the forward/rearward direction of the vehicle 10.

### Method of Controlling Vehicle

Hereinafter, a method of controlling a vehicle according to the present disclosure will be described with reference to the vehicle description and the drawings.

The method of controlling the vehicle according to the present disclosure may include a connection flow path closing step of closing a part of the connection flow path S by operating the opening/closing part 400 if a temperature of at least a partial region of the battery 30 exceeds a predetermined temperature. More specifically, in the connection flow path closing step, the blocking member 410 of the opening/closing part 400 may close the intermediate space S3 of the connection flow path S. Therefore, it is possible to prevent the fluid in the first flow path space S1 from being supplied to the second flow path space S2. That is, in the connection flow path closing step, the opening/closing part 400 may prevent the fluid, which is introduced into the connection flow path S through the second hole H2, from reaching the internal space of the vehicle.

Also, or alternatively, the method of controlling the vehicle according to the present disclosure may further include a fluid discharge step of discharging the fluid in the connection flow path S to the outside through the discharge hole H3. More specifically, the fluid discharge step may be performed if a predetermined time elapses after the connection flow path closing step is completed. The predetermined time may be the time taken for the pressure in the first flow path space S1 to exceed the predetermined pressure because the fluid in the first flow path space S1 cannot reach the second flow path space S2. More specifically, according to the present disclosure, in the fluid discharge step, the fluid may be discharged to the outside through the discharge hole H3 if the pressure in the region of the connection flow path S adjacent to the discharge hole H3, i.e., the pressure in the first flow path space S1 exceeds the predetermined pressure.

An object of the present disclosure is to improve the safety of a vehicle by preventing a gas produced from an air-cooled battery from being introduced into an internal space of the vehicle.

The present disclosure provides a vehicle configured to achieve the above object and solve other problems in the technological field. The vehicle may include a battery and a cooling flow path for cooling the battery, the vehicle including: an inlet part (e.g., an inlet) provided at one side of the vehicle and having a first hole configured to communicate with an internal space of the vehicle; an outlet part provided at the other side of the vehicle and having a second hole; a connection duct provided to face the outlet part and having a connection flow path configured to connect the outlet part and the internal space of the vehicle; and an opening/closing part having at least a component provided in the connection flow path of the connection duct, the opening/closing part being configured to control opening and closing between a region of the connection flow path, which faces the outlet part, and another region, in which the first hole and the second hole communicate with the cooling flow path.

A discharge hole may be formed at the other side of the vehicle and allow an external space of the vehicle and the connection flow path to communicate with each other, and the vehicle may further include a vent member provided in the discharge hole and configured to close the discharge hole, and the vent member may be configured to open the discharge hole if an applied pressure exceeds a predetermined pressure.

At least a part of the opening/closing part, the second hole, and the discharge hole may be provided in a space defined by the connection flow path.

The opening/closing part may include: a blocking member provided in an intermediate space (in the connection flow path) configured to connect a first flow path space of the connection flow path, which is connected to/in communication with the second hole and the discharge hole, and a second flow path space of the connection flow path that is connected to/in communication with the internal space of the vehicle. The intermediate space may be opened in a first state of the blocking member, and closed in a second state of the blocking member. A power supply member may be configured to operate (e.g., cause/move) the blocking member to be in the first state or the second state.

The blocking member may be configured to be movable between a first state in which the blocking member opens the intermediate space and a second state in which the blocking member closes the intermediate space.

The power supply member may include a rotary shaft configured to be rotatable, the blocking member may be coupled to the rotary shaft, the blocking member may have a predetermined first width in a direction perpendicular to a longitudinal direction of the rotary shaft and have a predetermined second width in a direction perpendicular to the longitudinal direction of the rotary shaft and the direction of the first width direction, the first width may be smaller than a width in an upward/downward direction of a region of the connection flow path in which the blocking member is provided, and the second width may correspond to the width in the upward/downward direction of the region of the connection flow path in which the blocking member is provided.

The power supply member may operate in the first state so that a surface, which defines the first width, is parallel to the upward/downward direction, and the power supply member may operate in the second state so that a surface, which defines the second width, is parallel to the upward/downward direction.

The first hole, the second hole, and the discharge hole may be formed in a floor surface of the vehicle.

The first hole and the discharge hole may be formed in a region between a front seat of the vehicle and a rear seat positioned rearward of the front seat.

The second hole may be formed in a lower region of the rear seat.

The opening/closing part may operate to close a part of the connection flow path if a temperature of at least a partial region of the battery exceeds a predetermined temperature.

A horizontal width of a cross-section, which is made by cutting the connection duct in a direction perpendicular to an extension direction of the connection duct, may be larger than a height in an upward/downward direction.

At least a part of a lower surface of the connection duct may be tightly attached to the floor surface.

The connection duct may include: a first duct region extending in a first direction and configured to define a region of the connection flow path that faces the first hole and the discharge hole; a second duct region extending in a second direction from an end of the first duct region; and a third duct region extending in a third direction from an end of the second duct region, the second direction may be formed to have a predetermined angle with respect to the first direction and the third direction, and the blocking member may be configured to open or close a connection flow path defined by the second duct region.

The first hole may be provided to be spaced apart from the connection duct, and the first hole may be provided to communicate with the internal space of the vehicle.

The opening/closing part may include a blocking member provided in an intermediate space configured to connect a first flow path space of the connection flow path, which is provided adjacent to the second hole and the discharge hole, and a second flow path space of the connection flow path that communicates with the internal space of the vehicle, and the blocking member may be configured to close the intermediate space while increasing in volume if a temperature exceeds a predetermined value.

In order to achieve the above-mentioned object, another aspect of the present disclosure provides a method of controlling the vehicle in which a discharge hole is formed at the other side of the vehicle and allows an external space of the vehicle and the connection flow path to communicate with each other, the method including: a connection flow path closing step of closing a part of the connection flow path by operating the opening/closing part if a temperature of at least a partial region of the battery exceeds a predetermined temperature; and a fluid discharge step of discharging the fluid in the connection flow path to the outside through the discharge hole, in which the opening/closing part prevents the fluid, which is introduced into the connection flow path through the second hole, from reaching the internal space of the vehicle in the connection flow path closing step, and in which the fluid is discharged to the outside through the discharge hole if a pressure in a region of the connection flow path, which is adjacent to the discharge hole, exceeds a predetermined pressure in the fluid discharge step.

According to the present disclosure, it is possible to improve the safety of the vehicle by preventing a gas produced from the battery from being introduced into the internal space of the vehicle in case that the battery in the vehicle is cooled in the air-cooled manner.

The present disclosure has been described with reference to the limited examples and the drawings, but the present disclosure is not limited thereby. The present disclosure may be carried out in various forms by those skilled in the art, to which the present disclosure pertains, within the technical spirit of the present disclosure and the scope equivalent to the appended claims.

What is claimed is:

1. A vehicle comprising:
a battery;
a cooling flow path configured to cool the battery via a fluid flowing through the cooling flow path;
an inlet forming a first hole in a first side of the vehicle, wherein the first hole is configured to communicate with an internal space of the vehicle;
an outlet forming a second hole in a second side of the vehicle;
a connection duct forming a connection flow path configured to connect the outlet and the internal space of the vehicle; and
an opening/closing part configured to control opening or closing between a first region, of the connection flow path, facing the outlet, and a second region, of the connection flow path, away from the outlet, wherein the first hole and the second hole are in communication with the cooling flow path.

2. The vehicle of claim 1, wherein the connection flow path is in communication with an external space to the vehicle via a discharge hole formed in the second side of the vehicle, and
wherein the vehicle further comprises a vent member provided in the discharge hole and configured to:
close the discharge hole if an applied pressure does not satisfy a threshold pressure, or
open the discharge hole if an applied pressure satisfies the threshold pressure.

3. The vehicle of claim 2, wherein the connection flow path defines a space comprising:
at least a part of the opening/closing part,
the second hole, and
the discharge hole.

4. The vehicle of claim 2, wherein the opening/closing part comprises:
a blocking member provided in an intermediate space configured to connect a first flow path space, of the connection flow path, in communication with the second hole and the discharge hole, to a second flow path space, of the connection flow path, in communication with the internal space of the vehicle; and
a power supply member configured to operate the blocking member.

5. The vehicle of claim 4, wherein the blocking member is configured to be movable between a first state in which the blocking member opens the intermediate space and a second state in which the blocking member closes the intermediate space.

6. The vehicle of claim 4, wherein the power supply member comprises a rotary shaft configured to be rotatable,
wherein the blocking member is coupled to the rotary shaft,
wherein the blocking member has a first width in a first dimension perpendicular to a longitudinal direction of the rotary shaft and has a second width in a second dimension perpendicular to the longitudinal direction of the rotary shaft and to the first dimension,
wherein the first width is smaller than a width in a first direction of the connection flow path in the intermediate space, and
wherein the second width corresponds to the width in the first direction.

7. The vehicle of claim 6, wherein the power supply member is configured to cause opening between the first region and the second region by orienting the blocking member such that the first dimension, characterized by the first width, to be parallel to the first direction, and
wherein the power supply member is configured to cause closing between the first region and the second region by orienting the blocking member such that the second dimension, characterized by the second width, to be parallel to the first direction.

8. The vehicle of claim 2, wherein the first hole, the second hole, and the discharge hole are formed in a floor surface of the vehicle.

9. The vehicle of claim 8, wherein the first hole and the discharge hole are formed in a region of the floor surface between a front seat of the vehicle and a rear seat positioned rearward of the front seat.

10. The vehicle of claim 9, wherein the second hole is formed in a region of the floor surface towards the rear seat relative to the first hole.

11. The vehicle of claim 1, wherein the opening/closing part is configured to, based on a temperature of the battery satisfying a threshold, close a part of the connection flow path.

12. The vehicle of claim 1, wherein a first width in a first direction of a cross-section of the connection duct perpendicular to an extension direction of the connection duct is larger than a second width, in a second direction perpendicular to the first direction, of the cross-section.

13. The vehicle of claim 8, wherein at least a part of the connection duct is tightly attached to the floor surface.

14. The vehicle of claim 4, wherein the connection duct comprises:
a first duct region extending in a first direction and comprising a region of the connection flow path in communication with the first hole and the discharge hole;
a second duct region extending in a second direction from an end of the first duct region; and
a third duct region extending in a third direction from an end of the second duct region,
wherein the second direction is not parallel to the first direction and is not parallel to the third direction, and
wherein the blocking member is configured to open or close a connection flow path through the second duct region.

15. The vehicle of claim 1, wherein the first hole spaced apart from the connection duct, and the first hole is configured to be in communication with the internal space of the vehicle.

16. The vehicle of claim 2, wherein the opening/closing part comprises a blocking member provided in an intermediate space configured to connect a first flow path space, of the connection flow path, in communication with the second hole and the discharge hole, to a second flow path space, of the connection flow path, in communication with the internal space of the vehicle, and
wherein the blocking member is configured to close the intermediate space by increasing, based on a temperature of the blocking member, in volume.

17. A method of controlling the vehicle of claim 1, the method comprising:
closing, based on a temperature of the battery exceeding a threshold temperature and via the opening/closing part, a part of the connection flow path; and
discharging, based on a pressure in a region of the connection flow path adjacent to a discharge hole satisfying a threshold pressure, the fluid in the connection flow path to an outside of the vehicle via the discharge hole,
wherein the closing configures the opening/closing part to prevent the fluid, introduced into the connection flow path via the second hole, from reaching the internal space of the vehicle.
